(19) United States
(12) Patent Application Publication
(10) Pub. No.: US 2012/0040847 A1
(43) Pub. Date: Feb. 16, 2012

(54) Personal Diabetic Carbohydrate Counting Procedure System and Method

(76) Inventors: Mitchell Charles MANS, Holly Springs, NC (US); Lena Wilson Mans, Holly Springs, NC (US)

(21) Appl. No.: 12/950,237

(22) Filed: Nov. 19, 2010

Related U.S. Application Data
(60) Provisional application No. 61/372,340, filed on Aug. 10, 2010.

(51) Int. Cl. C40B 30/02; G06F 19/00

(52) U.S. Cl. 506/8; 702/19

(57) ABSTRACT

A program interface for diabetic users to streamline the process of carbohydrate counting of meals. The present invention helps diabetic patients keep track of their blood glucose levels and help the users to calculate their require insulin intake for each meal. The invention comprises of a database of foods which users can select from for the calculation of nutrition and carbohydrates. The users are able to select their assigned carbohydrate to insulin ratio for the calculation of the amount of insulin that is required for the meal. Essential data is then stored and accessible for future corrective analysis.

The current application claims a priority to the U.S. Provisional Patent application Ser. No. 61/372,340 filed on Aug. 10, 2010.

### FIELD OF THE INVENTION

The present invention relates generally to a process or procedure, more specifically, to a diabetic maintenance procedure involving carbohydrate intake counting.

### BACKGROUND OF THE INVENTION

The present invention is a process developed over the years, providing a procedure and database for the maintenance and control of Diabetes. The term “Personal” is used to identify the need to establish a process for each individual under medical care. The present invention procedure provides a diet database for meal selection, with careful attention to diabetic needs, a selectable carbohydrate to insulin ratio, and the ability to select portions for menu item selections. Of particular interest to diabetics is the control of protein, sodium, fiber and potassium and selected calculations, indicating the effectiveness of control.

The resulting database when used by the physician, dietician and individual provides the means and knowledge to observe, track and modify their overall diabetic treatment. Although developed, primarily for Type One insulin users, requiring fast acting insulin, such as “Humalog”, which is taken before each meal, the diet process, particularly for those using insulin, when needed, may be used by Type Two (2) individuals as well.

### BRIEF DESCRIPTION OF THE DRAWINGS

FIG. 1 is a flowchart diagram that presents the overall process of the meal selection and final retention of blood glucose readings.

FIG. 2 is a detailed flowchart diagram showing the blood glucose reading process and the calculation of the moving average of the user's blood glucose level.

FIG. 3 is a detailed flowchart diagram showing the detailed food selection process.

FIG. 4 is a detailed flowchart diagram of the final steps in the process of the present invention showing the insulin requirement calculation.

FIG. 5 shows the entire initial display of the program interface of the present invention showing the meal selection buttons and the display of the procedure of using the software.

FIG. 6 displays the program interface showing food categories of a meal and the prompt for entering a blood glucose reading.

FIG. 7 shows the blood glucose reading entry window.

FIG. 8 shows the program interface with the calculated average blood glucose reading.

FIG. 9 shows the program interface displaying the foods of a selected food category on the food menu.

FIG. 10 shows the program interface displaying the nutrition facts of a selected food. The selection of a food also brings up the carbohydrate to insulin ratio menu and the serving size menu.

FIG. 11 shows the program interface when the serving size and carbohydrate to insulin ratio has been selected. The program interface displays the insulin dosage requirement for the meal.

FIG. 12 shows the program interface displaying a menu of fast food chains that users can select from.

FIG. 13 shows the data medium interfaced with the computing system.

### DETAIL DESCRIPTIONS OF THE INVENTION

All illustrations of the drawings are for the purpose of describing selected versions of the present invention and are not intended to limit the scope of the present invention.

The present invention is a program and method that streamlines the process and approach of maintaining diabetic treatment. The program provided by the present invention that has been primarily customized for type 1 diabetics or for diabetics that are insulin dependent. Insulin dependent diabetics use a combination of long or short time insulin. The diet process developed for diabetics is based on a long period of experience, medical consultation and food selections based primarily on the US Department of Agriculture (DOA). During these periods, various methods of control are tried, modified and refined. Inherent to all of the diet processes developed was the process of “carbohydrate” counting, exercise, and maintenance of records. Different insulin's were employed, under physician's care, with each change being a gradual process. Under any case, careful attention was paid to the diet process and finally to a “carbohydrate” counting and food selection procedure. Changes are always made under a physician's control, but in the end it was the patient's adherence to a studied process that yielded satisfactory results.

Diabetic control is a studied and deliberate process developed over the years as medications and understanding developed and improved. As a Type 2 patient, oral medications and exercise used to be the primary factors of controlling diabetes. However, when full insulin dependence became necessary, it was apparent that additional measures were necessary. “Intermediate Time” insulin's, such as NPH, were the only medications available. As a result, careful attention to diet and exercise were the essential elements for control. Initially, a daily NPH or “Intermediate Time” medication, with a “short time” Humalog, being employed at meal time was the protocol. Attention was always given to diet and food control, but the extensive use of “carbohydrate” counting was just being introduced and the data necessary for its utilization was in its infancy. A more detailed understanding of Humalog was also valuable. With the advent of careful marking of food content and the use of the USDOA Database, a detailed approach could finally be developed.

The combined use of Humalog, Lantus or and the USDOA Food Database provides a detailed “Carbohydrate-Counting” approach developed for an individual, since each person is different and requires a flexible systematic approach to understand and adjust.

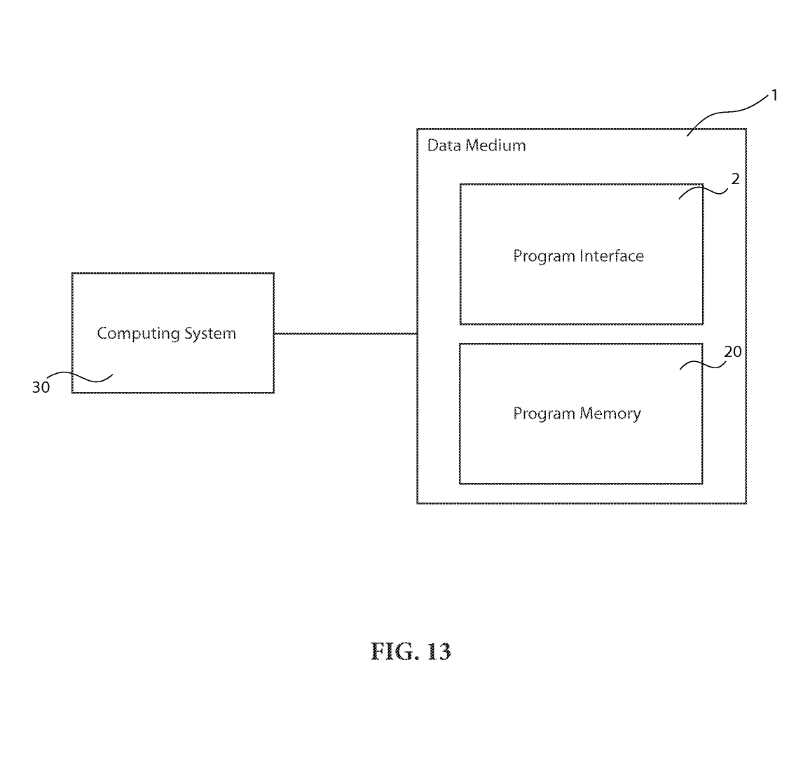

The present invention is a process using a software program system that assists diabetic users to easily count the carbohydrates they are consuming. The process and approach of present invention allows the user to keep track of their average blood glucose reading using a computing system 30 using a data medium 1. The data medium 1 can be any data storage device that is able including flash drives, compact discs, SD cards, or hard drives. The use of the flash drive as the data medium 1 provides users with portability, the ability to run the program of the present invention and store relevant data. In other embodiments of the present invention, the users can simply download the present invention from the internet or load the program from a CD and run it from their hard drives. The data medium 1 comprises a program interface 2 and a program memory 20. In reference to FIG. 13, to run the program interface 2 from the data medium 1, the user is required to load the data medium 1 on the computing system 30 by means of a USB interface, CD drive, or any other data storage device interface. The program is executed on the computing system 30 to bring up the program interface 2. The program introduced by the present invention is stored onto a data medium 1 such as a flash drive or SD card for portability and usage of electronic storage space. The use of flash drive allows the data stored about the user's history to be easily reviewed by a physician and/or dietitian. Utilization of the internet download procedure provides for user simplicity and continuing updates of programs and operational software.

The process of the present invention requires the program interface 2 to make use of several databases to perform its function of counting carbohydrates for the users. The databases used by the program interface 2 are stored in the program memory 20 of the data medium 1. The program interface 2 references and interacts with the databases to perform carbohydrate counting and inform diabetic users of nutritional information of their food selections. The databases included in the program memory 20 include a breakfast foods database 21, a lunch foods database 22, a dinner foods database 23, a snack foods database 24, a temporary total carbohydrate memory 25, an insulin dosage history 27, a meal history database 26, and a blood glucose reading database 28. The breakfast foods database 21, the lunch foods database 22, the dinner foods database 23, and the snack foods database 24 are reference databases that the program interface 2 accesses to retrieve nutritional fact information about a large variety of foods that are consistent with the United States Department of Agriculture food database. The temporary total carbohydrate memory 25 is a temporary data file that keeps track of the amount of carbohydrates of the foods selected during a session of counting carbohydrates. The blood glucose reading database 28 keeps track of all of the blood glucose reading history for the diabetic user and includes an array of blood glucose readings 282 and an array of blood glucose reading times 281. Each data value of the array of blood glucose readings 282 correspond with a value on the array of blood glucose reading times 281.

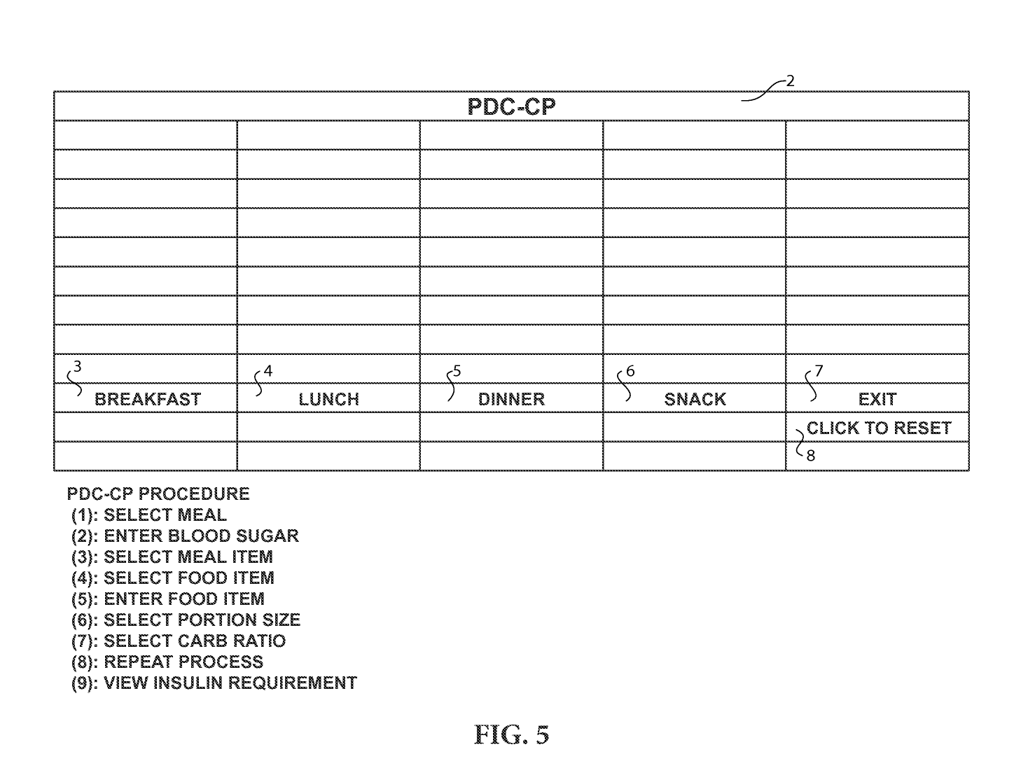

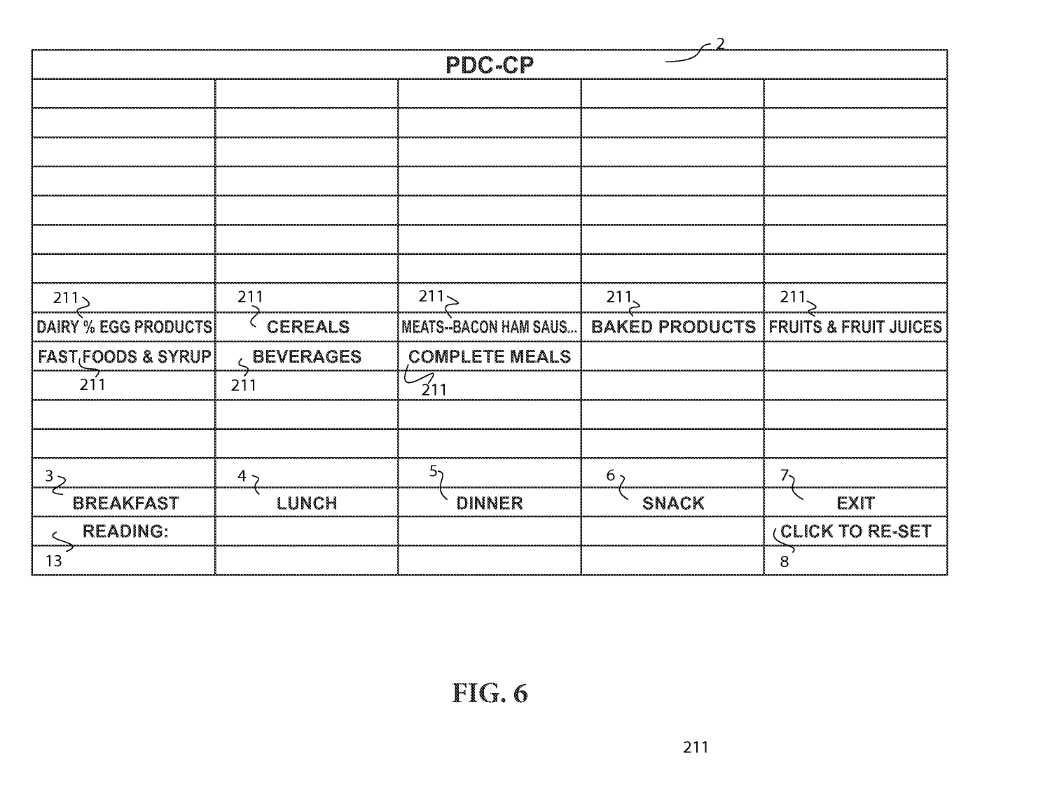

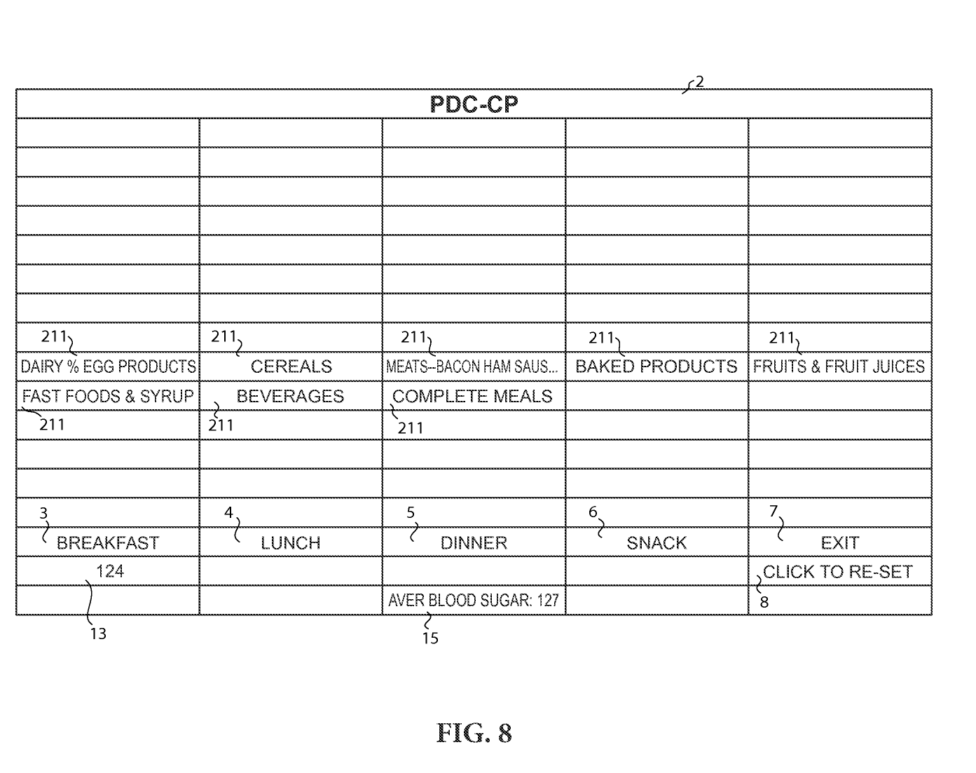

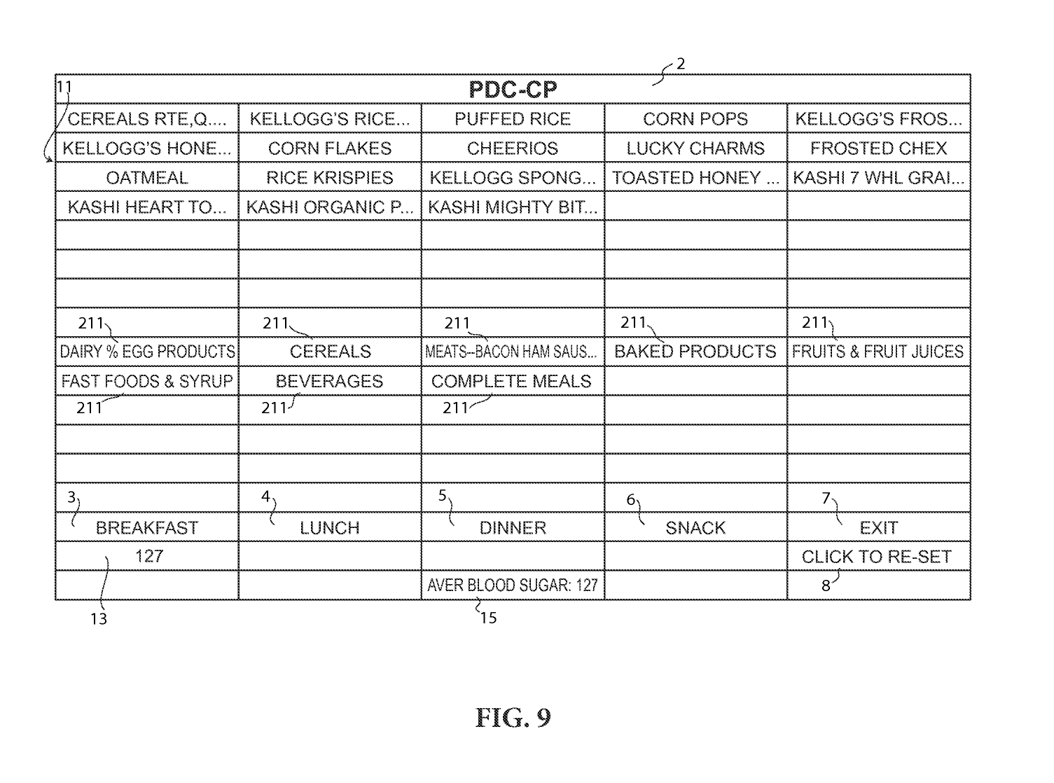

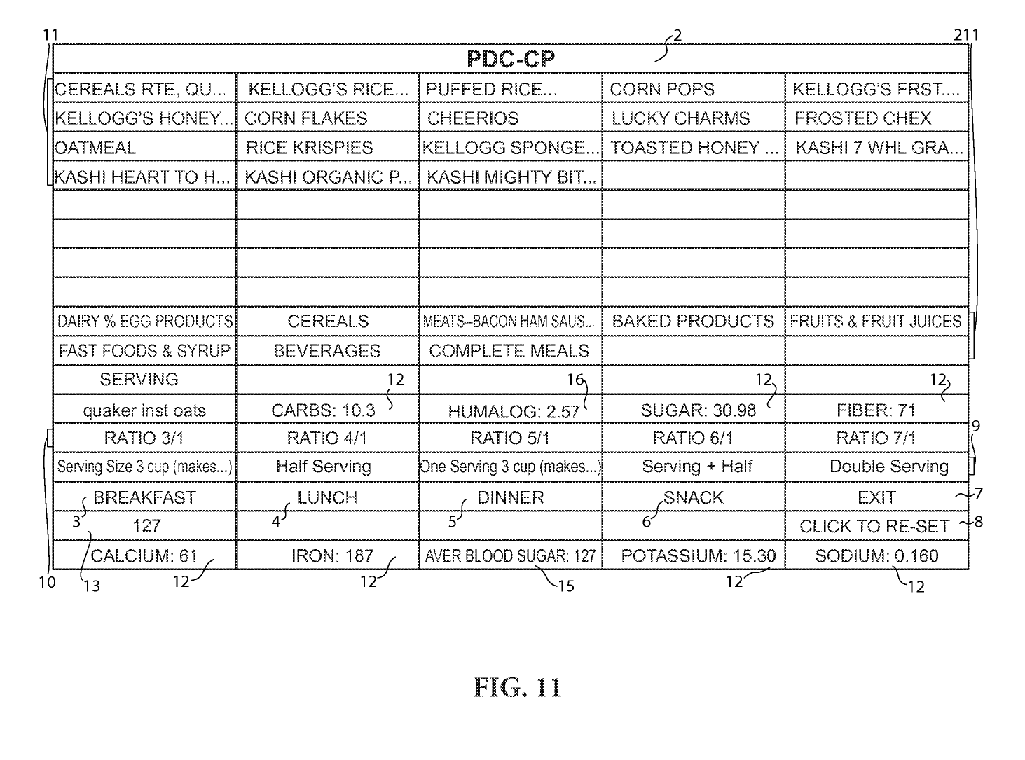

In reference to FIG. 5-12, the program interface 2 is an interface comprising a number of colored data display boxes and selection menus. Each time a user selects an item on the program interface 2 the selected display box changes to a contrasting color. The color contrast feature provided by the program interface 2 is beneficial for users that have visual disabilities. When the user first initializes the program, the program interface 2 provides the user with a meal menu to select the meal they are about to eat. Above the meal menu will be positioned a foods menu 11 that is blank initially. The meal menu comprises of a breakfast selection button 3, a lunch selection button 4, a dinner selection button 5, and a snack selection button 6. If the user is about to eat breakfast, the user will activate the breakfast selection button 3. As a result, the program interface 2 will access the breakfast food database 21 to display a plurality of breakfast food categories 211 for the user to select from. The categories of breakfast foods available for the plurality of breakfast food categories 211 includes dairy, egg products, cereals, meats, baked products, fruits, fruit juices, fast foods, syrups, beverages and complete meals. If the user is about to eat lunch, the user will activate the lunch selection button 4. As a result, the program interface 2 will access the lunch food database 22 to display a plurality of lunch food categories 221 for the user to select from. The categories of lunch foods available for the plurality of lunch foods include meats, bakery breads, fruits, fast foods, beverages, complete meals, poultry, seafood, and vegetables. If the user is about to eat dinner, the user will activate the dinner selection button 5. As a result, the program interface 2 will access the dinner food database 23 to display a plurality of dinner food categories 231 for the user to select from. The categories of dinner foods available for the plurality of dinner foods include milks, creams, beef, pork, bakery products, beverages, complete meals, chicken, sea foods, vegetables, soups, and desserts. If the user is about to have a snack, the user will activate the snack selection button 6. As a result, the program interface 2 will access the snack food database 24 to display a plurality of snack food categories 241 for the user to select from. The categories of snack foods available for the plurality of snack foods include beverages, fruits, snacks, sweets, chips, and nuts. However, in other embodiments of the present invention the plurality of breakfast food categories 211, the plurality of lunch food categories 221, the plurality of dinner food categories 231, and the plurality of snack food categories 241 can include other food categories that are suitable for people with diabetes.

Once the user selects the meal they are about to eat, a blood glucose button 13 will appear below the meal menu corresponding to the meal they have selected. The user will select the blood glucose button 13 to enter and record their last blood glucose reading. The activation of the blood glucose button 13 will display a blood glucose reading entry window 14. The blood glucose reading entry window 14 includes a blood glucose reading entry field 141 where the user will be able to enter their last blood glucose reading value. Once the user enters their last blood glucose reading value, the program interface 2 will record the time of their blood glucose reading and the blood glucose reading value into the array of blood glucose reading times 281 and the array of blood glucose readings, respectively. After the user enters reading, the blood glucose button 13 also acts as a display showing the current blood sugar reading when the user is interacting with the program interface 2. The computing system 30 will then calculate the average blood glucose reading 283 from the array of blood glucose readings. The program interface 2 will then display the average glucose reading in an average blood glucose reading display 15. Once the user has entered the last blood glucose reading value, the user will be able to select specific foods they are eating depending on the meal using the category selection menu. By activating the categories of foods, the program interface 2 will access the program memory 20 to display an array of specific foods pertaining to the category selected. The user will then be able to select the foods they will be eating for the meal.

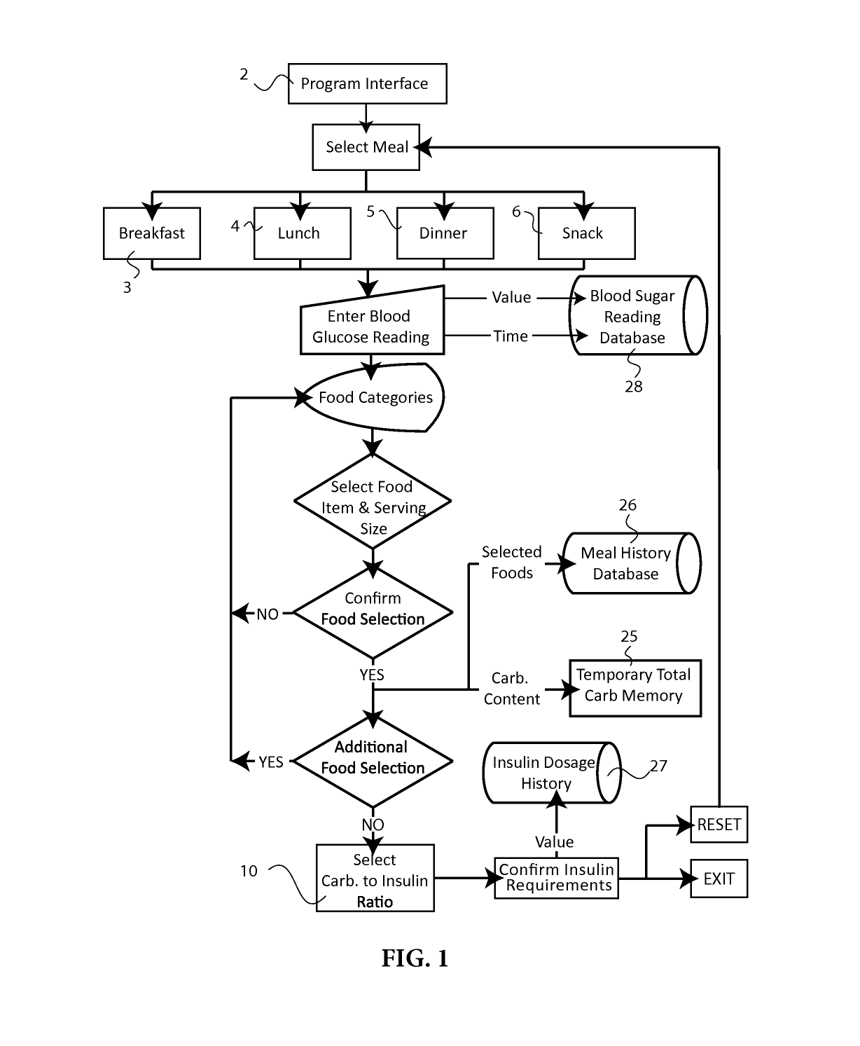

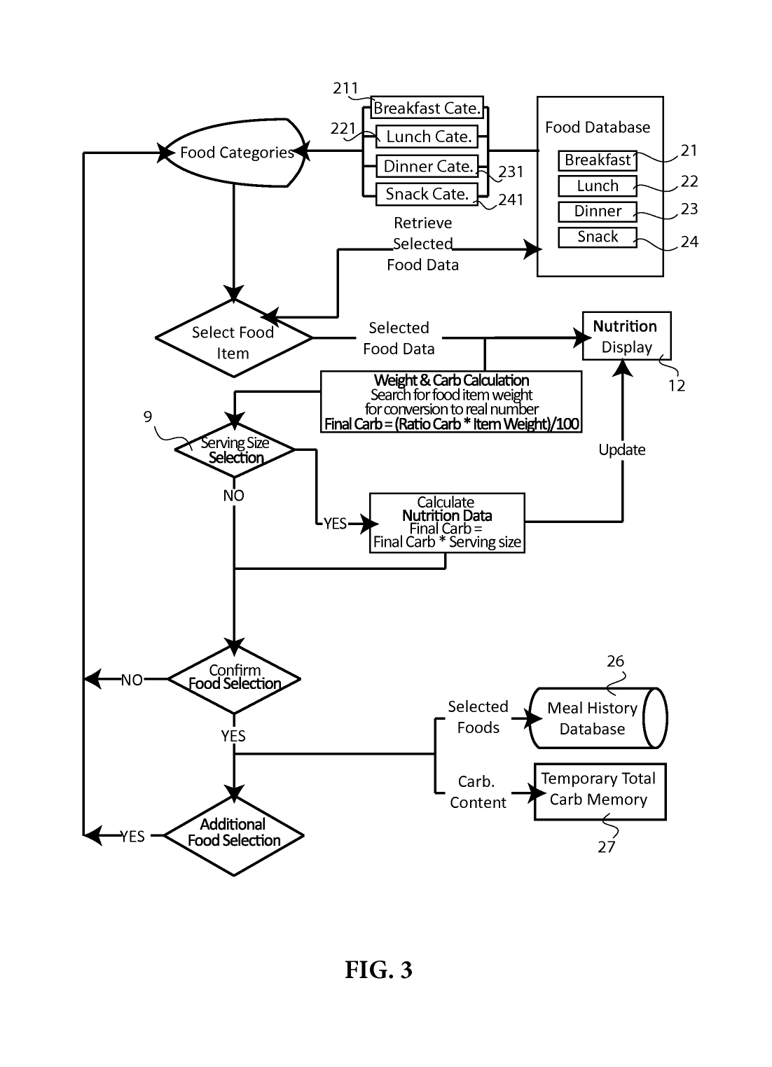

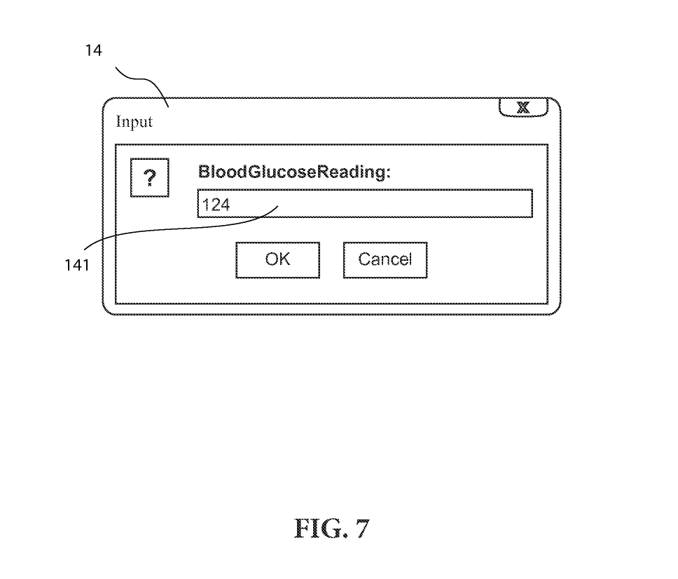

In reference to FIG. 1, FIG. 3, and FIG. 7, once the user selects a food item from the foods menu 11, the program interface 2 will access either the breakfast food database, the lunch food database, the dinner food database, or the snack food database to retrieve the nutrition facts of the food item selected. The nutrition facts will be displayed on a nutrition fact display 12 of the program interface 2. In the preferred embodiment of the present invention, the nutrition facts displayed will be include amount of carbohydrates, sugar, fiber, calcium, iron, potassium, and sodium. By default, the program interface 2 will display the nutrition facts of the selected food item for one serving size. Once the nutrition facts of the selected food item are displayed, the user is able to choose the serving size of the selected foods they will be eating for the meal from a serving size selection menu 9. The serving size will determine and modify the nutrition facts displayed. The relationship between the amount of nutrition of the food selected and the serving size is proportional by weight, with the default being the full serving size. For example, if the carbohydrate content of a selected food for one serving is 24 grams, then the carbohydrate contents of the selected food for ½ serving will be 12 grams. Once the serving size for a selected food is chosen, the user will confirm the selected serving size. The carbohydrate content of the selected food item is then recorded into the temporary total carbohydrate memory 25. The amount of food per serving size is based upon the foods databases provided by the US Department of Agriculture. The user is able to continue selecting and confirming other food items by repeating the same procedure of selecting food items and serving size. The temporary total carbohydrate memory 25 will keep track of all the carbohydrate contents of each confirmed food item selected for the session.

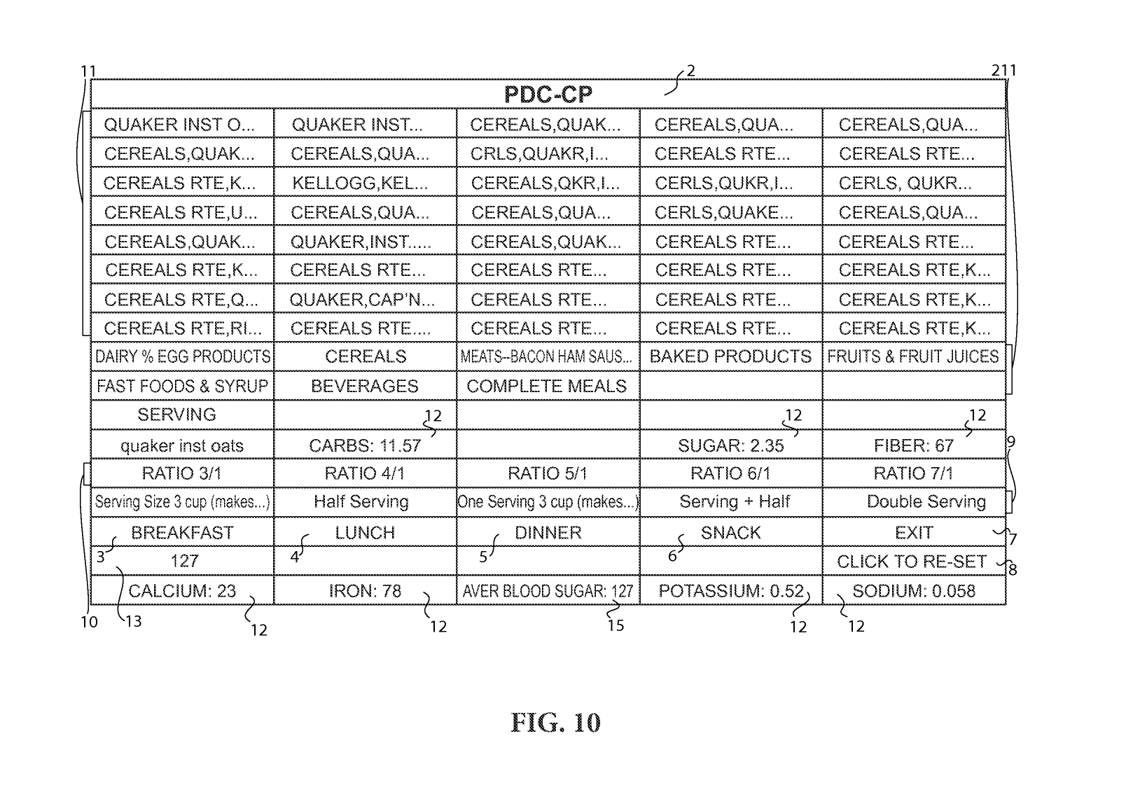

In reference to FIG. 10, once all food items for the meal has been selected and confirmed, the user will be able to select a carbohydrate to insulin ratio that has been personalized for their diet from a carbohydrate to insulin ratio menu 10. The carbohydrate to insulin ratio menu 10 will include several carbohydrates to insulin ratios for the user to choose from. Each diabetic person will vary in the amount of insulin they must take per amount of carbohydrates. The carbohydrate to insulin ratio is dependent on the user's blood glucose reading history and is adjusted to help users reach their desired blood glucose target. Insulin is a key hormone in the body that helps diabetic patient uptake glucose into their system for energy. Insulin also prevents glucose from being taken from carbohydrates and left in the blood stream. The carbohydrate to insulin ratio chosen will help the user determine required insulin intake that needs to be taken for the meal. For example, if the total amount of carbohydrate content in a meal is 60 g and a diabetic patient's carbohydrate to insulin ratio is 6:1, the patient is required to take 10 units of insulin for the meal. After the user has chosen the carbohydrate to insulin ratio, the program interface 2 will automatically sum all of the carbohydrate data stored in the temporary total carbohydrate memory 25 and calculate the insulin intake requirement. The amount of insulin required for the meal is calculated by dividing the total amount of carbohydrates for the meal by the carbohydrate to insulin ratio. The insulin intake requirement is then displayed on a required insulin dosage indicator 16. In the preferred embodiment of the present invention, the insulin intake requirement displayed on the required insulin dosage indicator 16 will be for rapid acting insulin. The dosage of rapid acting insulin is taken at the same time that the meal is eaten. In the preferred embodiment of the present invention, the when the user confirms the selected food items for a meal, the program interface 2 is provided a flag indicator to indicate the requirement for a blood glucose reading. After the insulin dosage has been taken and the selected meal has been eaten, the user is required to take a post meal blood glucose reading two hours after the meal. The user will then record the blood glucose reading into blood glucose reading database 28 through the program interface 2.

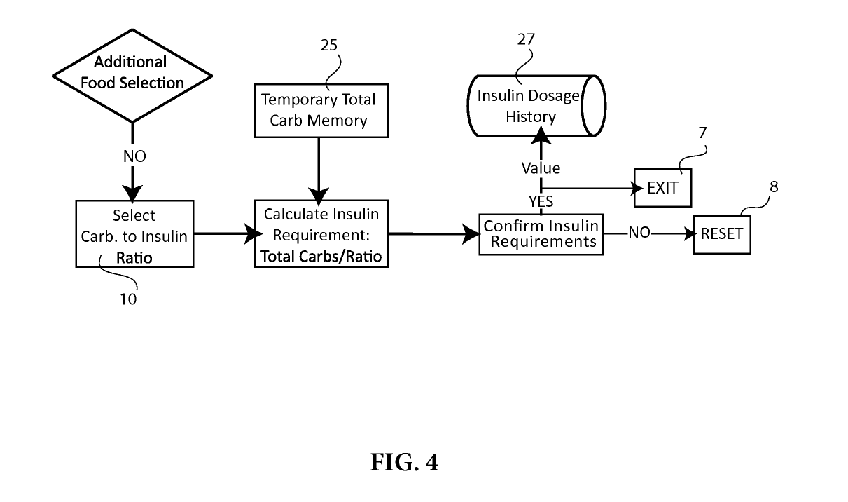

In reference to FIG. 1 and FIG. 4, the user can choose to end or restart a session on the program interface 2 by means of an exit button 7 and a reset button 8. When the process of carbohydrate counting and insulin requirement calculating with the program interface 2 has been completed, the user will be able to close the program interface 2 and end the session by selecting the exit button 7. The exit button 7 allows the interface to finalize and record all of the selected and confirmed food items of the meal to the meal history database 26. The reset button 8 will allow users to reset the selected and confirmed foods when a mistake has been made. Since one wishes to take as little insulin as possible, the selections of foods may yield too high of an insulin requirement. With too high of an insulin requirement, the user may want to reconsider the selections of foods and restarted to entire selection process. By activating the reset button 8, the temporary total carbohydrate memory 25 is cleared and the entire program interface 2 is reinitialized as a new session. If too much insulin is taken, the blood glucose level will drop dramatically. This dramatic drop in blood glucose will induce hypoglycemia in the user. However, if the insulin dosage requirement for the meal is accepted and confirmed by the user, the program interface 2 will record the insulin dosage into the insulin dosage history 27.

The sequence of events for the procedure of using the present invention is as follows:
1. Select “MEAL” or “SNACK”
2. Enter Last Blood Glucose Reading.
3. Select “MENU ITEM”
4. Select “FOOD ITEM”, re-select until satisfied
5. “ENTER SELECTED FOOD ITEM”
6. Select Portion Size.
7. Repeat process until complete meal has been selected.
8. Select Carbohydrate to insulin ratio.
9. Observe computed insulin requirement.
10. If satisfactory, select “EXIT”. This will update the database with the entered blood glucose reading. Selecting “RESET” will restart the process.

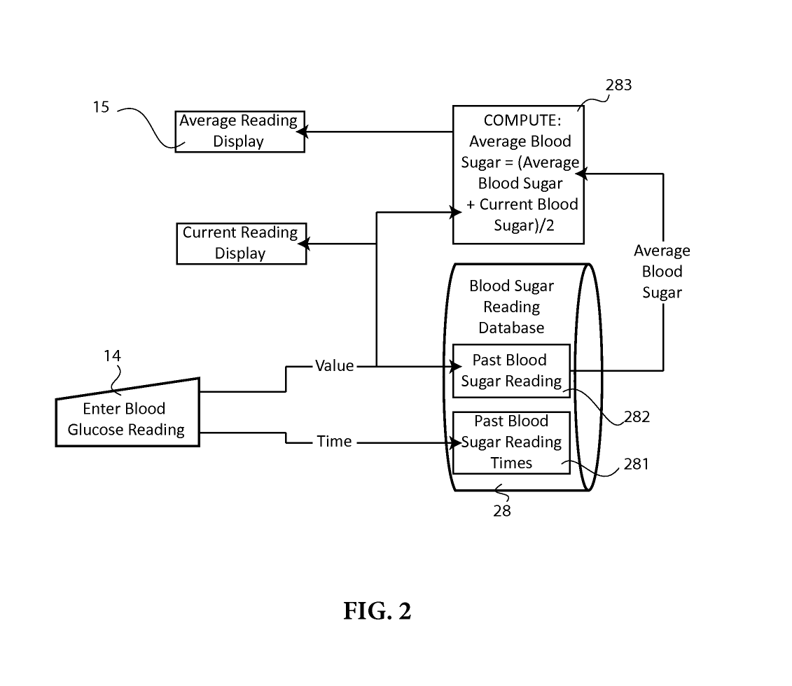

The present invention being on a portable data medium 1 such as a flash drive or SD card allows users to utilize the program interface 2 anywhere there is access to a computing system 30. The present invention provides users with a simple step by step process, as shown in FIG. 1-4, which provides a method to keep a complete and detailed record of daily menu items, blood glucose reading times 281, and blood glucose reading quantities. Using such information, the carbohydrate to insulin ratios may be adjusted after consultation with a physician. More importantly, with the present invention keeping track of the blood glucose reading history, the meal history, and the insulin dosage history 27, physicians and consulting dieticians are provided with an analytical process for an effective control of one's diabetes. To effectively control one's diabetes, the carbohydrate to insulin ratio is modified periodically depending on the blood glucose reading history. The carbohydrate to insulin ratio is important to maintaining a target blood glucose level for a diabetic patient. The carbohydrate to insulin ratio determines the amount of insulin a diabetic patent is required to intake for each meal. The amount of insulin directly affects the blood glucose reading for the diabetic patient. By controlling the carbohydrate to insulin ratio, a diabetic patient is able to achieve a desired maintenance level of blood glucose determined suitable by a physician.

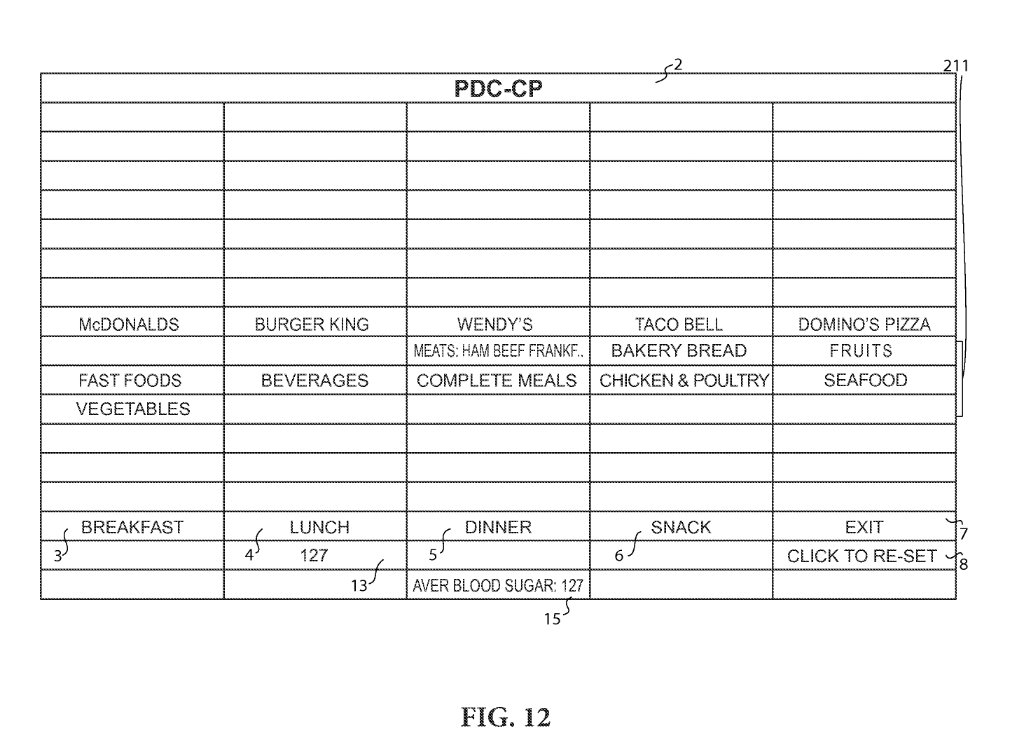

In the preferred embodiment of the present invention, the food selections for each meal or snacks are based on “better” selections for diabetics. More specifically, the food databases for each meal include foods that are relatively low in carbohydrates and sugar content. In contrast, snacks are sometimes needed between meals or at bedtime for the maintenance of blood glucose levels and may provide enriched carbohydrates or sugar contents to prevent low blood glucose levels. Any sweets, syrups and desserts such as ice cream in the foods database are selected based on low sugar and low fat contents. In essence, the healthiest possible meals are contained in the existing database. The selections may be custom designed for specific applications. The database provided by the DOA contains approximately 8400 menu items. However, in the preferred embodiment of the present invention, not all of the menu items are included. For example, cereals that are similar in terms of nutrients with other cereals or many food items that possess high amounts of carbohydrates or sugar content were not included. In the preferred embodiment, the present invention included fast food restaurants in the foods databases base on popularity such as McDonalds's, Burger King, Wendy's, Taco Bell, and Domino's pizza as shown in FIG. 12. Although the menu items were selected primarily on diabetic constraints, the database can be tailored to any specific needs. Additionally, beverage selections, while generally not high in carbohydrates, do contain sugar and are considered a part of any menu selection.

Although the invention has been explained in relation to its preferred embodiment, it is to be understood that many other possible modifications and variations can be made without departing from the spirit and scope of the invention as hereinafter claimed.

1. The personal diabetic carbohydrate-counting procedure system comprises,
a data medium;
a computing system;
the data medium comprises a program interface and a program memory;
the program interface comprises of a breakfast selection button, a lunch selection button, a dinner selection button, a snack selection button, an exit button, a reset button, a serving size selection menu, a carbohydrate to insulin ratio menu, a foods menu, a nutrition fact display, a blood glucose button, a blood glucose reading entry window, average blood glucose reading display, and required insulin dosage indicator;
the program memory comprises a breakfast foods database, a lunch foods database, a dinner foods database, a snack foods database, a temporary total carbohydrate memory, a meal history database, an insulin dosage history, and a blood glucose reading database;
the data medium being a storage device selected from the group consisting of a flash drive, a CD drive, an SD card, and website server;
the breakfast food database includes a plurality of breakfast food categories;
the lunch food database includes a plurality of lunch food categories;
the dinner food database includes a plurality of dinner food categories;
the snack food database includes a plurality of snack food categories;
the blood glucose reading entry window comprises a blood glucose reading entry field; and
the blood glucose reading database comprises of an array of blood glucose reading times and an array of blood glucose readings.

2. (canceled)

3. (canceled)

4. (canceled)

5. (canceled)

6. The personal diabetic carbohydrate-counting procedure system as claimed in claim 1 comprises, the plurality of breakfast food categories are foods selected from the group consisting of dairy, egg products, cereals, meats, baked products, fruits, fruit juices, fast foods, syrups, beverages and complete meals.

7. The personal diabetic carbohydrate-counting procedure system as claimed in claim 1 comprises, the plurality of lunch food categories are foods selected from the group consisting of meats, bakery breads, fruits, fast foods, beverages, complete meals, poultry, seafood, and vegetables.

8. The personal diabetic carbohydrate-counting procedure system as claimed in claim 1 comprises, the plurality of dinner food categories are foods selected from the group consisting of milks, creams, beef, pork, bakery products, beverages, complete meals, chicken, sea foods, vegetables, soups, and desserts.

9. The personal diabetic carbohydrate-counting procedure system as claimed in claim 1 comprises, the plurality of snack food categories are foods selected from the group consisting of beverages, fruits, snacks, sweets, chips, and nuts.

10. A method of personal diabetic carbohydrate-counting procedure system process comprises,
Loading a data storage medium on a computing system, wherein the data storage medium is a USB flash drive, SD card, CD drive, or website;
providing, by the data storage medium a breakfast foods database, a lunch foods database, a dinner foods database, a snack foods database, a temporary total carbohydrate memory, a meal history database, an insulin dosage history, and a blood glucose reading database;
providing, by the data storage medium a program interface including a breakfast selection button, a lunch selection button a dinner selection button, a snack selection button, an exit button, a reset button, a serving size selection menu, a carbohydrate to insulin ratio menu, a foods menu, a nutrition fact display, a blood glucose button, a blood glucose reading entry window, an average blood glucose reading display, and a required insulin dosage indicator; and
selecting the breakfast selection button, the lunch selection button, the dinner selection button depending on meal time.

11. The method of personal diabetic carbohydrate-counting procedure system as claim in claim 10 comprises,
activating the breakfast selection button;
accessing the breakfast food database to display the breakfast foods on the foods menu;
activating the lunch selection button;
accessing the lunch food database to display the lunch foods on the foods menu;
activating the dinner selection button;
accessing the dinner food database to display the dinner foods on the foods menu;
activating the snack selection button; and
accessing the snack food database to display the snack foods on the foods menu.

12. The method of personal diabetic carbohydrate-counting procedure system as claim in claim 10 comprises,
selecting the reset button to clear selections and restart the program interface; and
selecting the exit button to exit the program interface.

13. The method of personal diabetic carbohydrate-counting procedure system as claim in claim 10 comprises,
providing an array of blood glucose reading times and an array of blood glucose readings by the blood glucose reading database;
selecting the blood glucose button to display the blood glucose reading window;
providing a blood glucose reading entry field by the blood glucose reading window;
taking a blood glucose reading;
entering blood glucose reading into blood glucose reading entry field;
recording of time entering blood glucose reading into the array of blood glucose reading times;
recording blood glucose reading into the array of blood glucose readings;
calculating the average blood glucose reading from the array of blood glucose readings; and
displaying the average blood glucose reading in the average blood glucose reading display.

14. The method of personal diabetic carbohydrate-counting procedure system as claim in claim 13 comprises,
selecting at least one food item displayed on the foods menu;
accessing nutrition facts of selected foods from the breakfast food database, lunch food data base, the dinner food database, or the snack food database;
displaying nutrition facts of the selected foods on the nutrition facts display;
selecting a serving size for selected food item from the serving size selection menu;
calculating carbohydrate data of the at least one food item corresponding to the serving size selected by accessing the nutrition facts;
confirming the at least one food item selected from the foods menu;
recording the selected food item into the meal history database;
storing the carbohydrate data calculated for the selected food into the temporary total carbohydrate memory; and
selecting a carbohydrate to insulin ratio from the carbohydrate to insulin ratio menu.

15. The method of personal diabetic carbohydrate-counting procedure system as claim in claim 14 comprises,
summing the stored carbohydrate data;
calculating an insulin intake requirement by dividing the summed carbohydrate data stored in the temporary total carbohydrate memory with the carbohydrate to insulin ratio;
displaying the insulin intake requirement on the required insulin dosage indicator;
recording the insulin intake requirement into the insulin dosage history;
taking a post meal blood glucose reading; and
recording the post meal blood glucose reading into the blood glucose database by means of the blood glucose reading entry window.

16. The method of personal diabetic carbohydrate-counting procedure system as claim in claim 13 comprises,
the nutrition fact display includes sugar content, fiber content, calcium content, iron content, potassium contents, and sodium contents; and
observing of the blood glucose reading database in conjunction with the meal history database are data files for modification or maintenance of diabetic treatment.

17. A method of personal diabetic carbohydrate-counting procedure system comprises,
Loading a data storage medium on a computing system, wherein the data storage medium is a USB flash drive, SD card, CD drive, or website;
providing, by the data storage medium, a breakfast foods database, a lunch foods database, a dinner foods database, a snack foods database, a temporary total carbohydrate memory, a meal history database, an insulin dosage history, and a blood glucose reading database;
providing, by the data storage medium, an program interface including a breakfast selection button, a lunch selection button a dinner selection button, a snack selection button, an exit button, a reset button, a serving size selection menu, a carbohydrate to insulin ratio menu, a foods menu, a nutrition fact display, a blood glucose button, a blood glucose reading entry window, an average blood glucose reading display, and a required insulin dosage indicator;
selecting the breakfast selection button, the lunch selection button, the dinner selection button depending on meal time;
activating the breakfast selection button;
accessing the breakfast food database to display the breakfast foods on the foods menu;
activating the lunch selection button;
accessing the lunch food database to display the lunch foods on the foods menu;
activating the dinner selection button;
accessing the dinner food database to display the dinner foods on the foods menu;
activating the snack selection button;
accessing the snack food database to display the snack foods on the foods menu;
providing an array of blood glucose reading times and an array of blood glucose readings by the blood glucose reading database;
selecting the blood glucose button to display the blood glucose reading window;
providing a blood glucose reading entry field by the blood glucose reading window;
taking a blood glucose reading; and
entering blood glucose reading into blood glucose reading entry field.

18. The method of personal diabetic carbohydrate-counting procedure system as claim in claim 17 comprises,
selecting the reset button to clear selections and restart the program interface;
selecting the exit button to exit the program interface;
the nutrition fact display includes sugar content, fiber content, calcium content, iron content, potassium contents, and sodium contents; and
observing of the blood glucose reading database in conjunction with the meal history database are data files for modification or maintenance of diabetic treatment.

19. The method of personal diabetic carbohydrate-counting procedure system as claim in claim 17 comprises,
recording of time entering blood glucose reading into the array of blood glucose reading times;
recording blood glucose reading into the array of blood glucose readings;
calculating the average blood glucose reading from the array of blood glucose readings;
displaying the average blood glucose reading in the average blood glucose reading display;
selecting at least one food item displayed on the foods menu;
accessing nutrition facts of selected foods from the breakfast food database, lunch food data base, the dinner food database, or the snack food database;
displaying nutrition facts of the selected foods on the nutrition facts display;
selecting a serving size for selected food item from the serving size selection menu;
calculating carbohydrate data of the at least one food item corresponding to the serving size selected by accessing the nutrition facts;
confirming the at least one food item selected from the foods menu;
recording the selected food item into the meal history database;
storing the carbohydrate data calculated for the selected food into the temporary total carbohydrate memory; and
selecting a carbohydrate to insulin ratio from the carbohydrate to insulin ratio menu.

20. The method of personal diabetic carbohydrate-counting procedure system as claim in claim 19 comprises,
summing the stored carbohydrate data;
calculating an insulin intake requirement by dividing the summed carbohydrate data stored in the temporary total carbohydrate memory with the carbohydrate to insulin ratio;
displaying the insulin intake requirement on the required insulin dosage indicator;
recording the insulin intake requirement into the insulin dosage history;
taking a post meal blood glucose reading; and
recording the post meal blood glucose reading into the blood glucose database by means of the blood glucose reading entry window.
